(19) United States
(12) Patent Application Publication
(10) Pub. No.: US 2003/0074194 A1
(43) Pub. Date: Apr. 17, 2003

(54) Fluid dispensing apparatus

(76) Inventor: Robert Martin Finnegan, Waterford (IE)

Correspondence Address: Akerman Senterfitt & Eidson, Post Office Box 3188, West Palm Beach, FL, 33402-3188, US

(21) Appl. No.: 10/149,158

(22) PCT Filed: Dec. 7, 2000
(86) PCT No.: PCT/GB00/04679

(30) Foreign Application Priority Data
Dec. 8, 1999 (GB) 9928904.3
Apr. 15, 2001 (GB) 0009271.8
Sep. 7, 2000 (GB) 0022001.2

(51) Int. Cl. G10L 15/00

(52) U.S. Cl. 704/231

(57) ABSTRACT

A dispenser (40) for drinking water which comprises communications means (42, 44) for relaying sensed data or inputted data to a remote location (110). The sensed data may relate to usage and/or to operation of the apparatus. The apparatus may also include means for generating said sensed data, such as for example means for measuring flow of fluid through said fluid supply path.

This invention relates generally to fluid dispensing apparatus, and more particularly to apparatus for dispensing fluid from containers.

Many different types of fluid dispensing apparatus have previously been proposed, and aspects of the present invention will now be described with particular reference to so-called “water coolers” or “bottled-water dispensers”. Water coolers or bottled water dispensers. as referred to herein. are defined as apparatus adapted for the dispense of water (not necessarily cooled water) from a container—which need not necessarily be a bottle. However, it should be noted that the teachings of this invention are not limited to this particular field, and could be applied for example to other types of fluid dispensing apparatus which may or may not include a cooling function (or indeed to apparatus for dispensing other types of fluid).

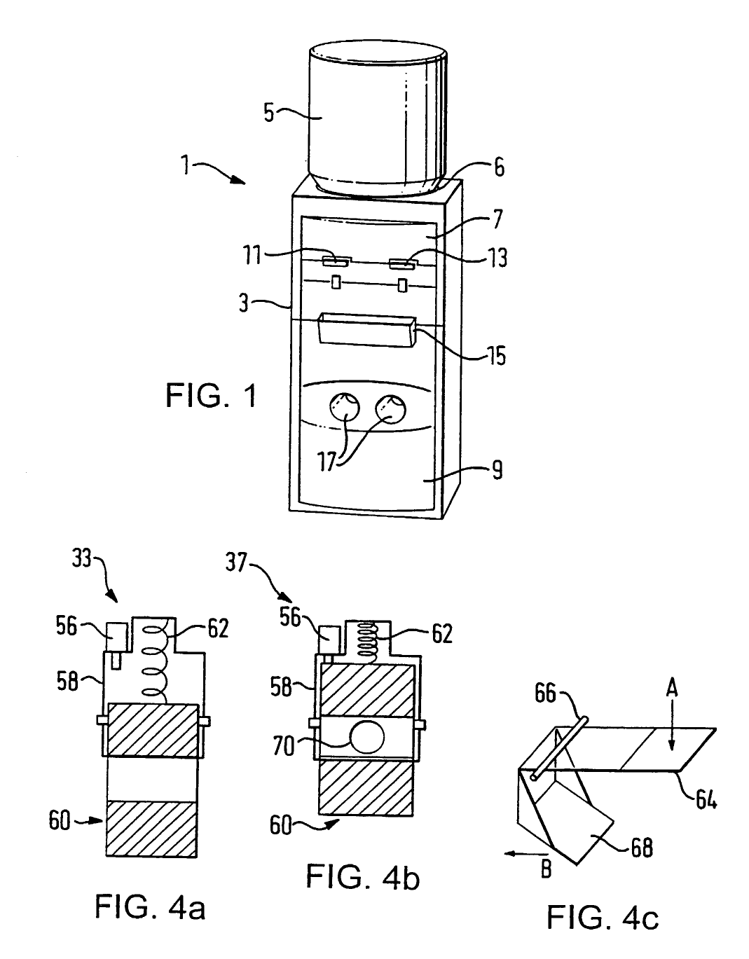

FIG. 1 shows an example of a previously proposed water dispenser which is capable of supplying drinking water to a user. The dispenser illustrated includes a chiller to provide chilled drinking water.

As shown, the water dispenser I comprises a cabinet 3 onto which a water bottle 5 has been mounted. The water bottle is typically of plastic so that it is relatively inexpensive to manufacture, but it could instead be of glass or other suitable material. The water bottle engages with a socket 6 provided on a top surface of the dispenser.

The cabinet 3 has a front cover which is generally divided into a top half 7 and a bottom half 9, both halves of the cover being detachable from the cabinet to permit access to the interior of the dispenser. Projecting through the top cover 7 are a pair of levers 11, 13 which when depressed open respective valves located within the cooler to allow water to flow into a cup held by a user therebelow. A drip tray 15 is provided to capture any spillage that might occur as or after water is dispensed.

The bottom half 9 of the cover includes a pair of cup dispensers 17 into which stacks of cups, for example disposable plastic cups, can be loaded. The cup dispensers each comprise a tube with a plunger which is spring biased to push cups loaded therein through an aperture in the cover.

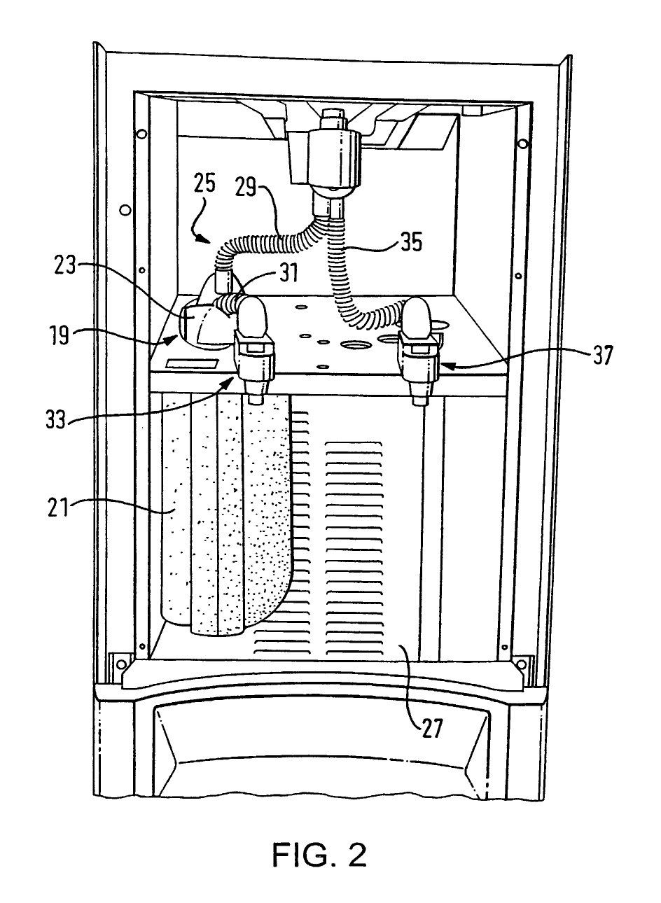

FIG. 2 is a schematic view of part of the dispenser of FIG. 1 with the top cover 7 removed to permit access to the interior. As shown, the dispenser includes a chiller cavity 19 which comprises an insulating jacket 21 within which evaporator piping (not visible) of a refrigerant circuit is coiled.

A bag 23 of a so-called water trail 25 is located within the chiller cavity 19, and is continuously refilled with water when a bottle is mounted on the water dispenser 1. Advantageously, the entire water trail is removable and can be disposed of thereby avoiding the cleaning processes associated with water dispensers that have a fixed water trail. As a further advantage of this arrangement, the valves do not need come into contact with water in the water trail as they act simply to pinch closed tubing of the water trail.

The refrigerant circuit comprises a compressor (not shown) which compresses vapour refrigerant before passing it to a condenser 27 located on the rear of the cabinet 1. The condenser 27 is basically a heat exchanger which transfers heat from the compressed vapour refrigerant to the ambient air to cause the refrigerant to change state to a high pressure liquid. The high pressure liquid refrigerant exiting from the condenser 27 is then passed to the evaporator piping coiled within the insulating jacket 21 via an expansion valve (not shown). As the liquid refrigerant passes through the expansion valve, the pressure and temperature of the refrigerant is reduced before it is passed to the coiled evaporator piping where it draws heat from, and hence chills, water contained within the bag 23 that is located within the insulating jacket 21. As the liquid refrigerant passes through the evaporator piping and draws heat from the water within the bag 23, it changes state into a low pressure vapour before being recirculated through the refrigeration circuit by the compressor.

Tubes 29, 31 connect the bag 23 of the water trail 25 to the socket 6 of the water dispenser and to a first valve 33 which can be opened by means of a first one 11 of the above mentioned levers 11, 13. A further tube 35, in this particular arrangement, bypasses the chiller cavity and directly connects a second valve 37 to the socket 6. The second valve can be opened by means of a second one 13 of the above mentioned levers to supply water at the ambient temperature (i.e. water which has not been chilled).

Water dispensers such as those shown in FIGS. 1 and 2 are typically rented or loaned to customers. Fresh supplies of water bottles are either delivered to the customers on a regular basis or alternatively the customers must contact the supplier and ask for a delivery when their stock of water bottles is running low.

Similarly, if the water dispenser provided to a given customer should develop a fault, then it is up to the customer to recognise that there is something wrong with their dispenser and call the supplier to advise them that their dispenser needs servicing. It could conceivably be several days before a customer notices, for example, that the water dispenser is no longer dispensing chilled water and it could be still longer before the customer actually gets round to reporting the fault to the supplier.

These existing arrangements are expensive for the supplier to implement and maintain, as they require the supplier to provide sufficient staff to deal effectively with the customers. They can also be inconvenient for customers who at busy times of the day can often find it difficult to contact their supplier.

In addition, the suppliers typically have to maintain a large stock of water bottles as it is difficult, if not impossible, for them to predict the number of bottles they will need to have in stock for a future period. The customers also have to be able to find sufficient space to enable them to store a number of replacement water bottles at any one time.

It is also not unusual for customers or suppliers to run out of water bottles, as customers can sometimes forget to place an order and a sudden unexpected increase in orders, as might happen during a heat wave for example, can cause the supplier to be unable to meet demand.

The present invention has been conceived in the light of these problems, and it is an object of the invention to address and alleviate those problems.

In its broadest concept, the present invention provides a dispenser for drinking water which comprises communications means for relaying sensed data or inputted data to a remote location.

In this way, the above described problems can be alleviated as sensed data relating to the operating state of the dispenser or dispenser components (for example the presence or otherwise of a water bottle, the water temperature (which can indicate the state of a chiller circuit), or the presence or otherwise of a power supply); or sensed data relating to the environment in which the dispenser is located (for example the ambient temperature); or sensed data relating to dispenser usage characteristics (for example the amount of water dispensed) can be relayed to a remote location where the supplier can take appropriate action without having to wait for the customer to make contact.

Similarly, the customer could input data, relating for example to an order of fresh water bottles, into the dispenser for relay to the remote location without having to telephone the supplier at the remote location and possibly be delayed.

A variety of other types of data can also be relayed, and thus the above list should not be taken as being exhaustive.

Preferably, the dispenser comprises a fluid supply path, and valve means operable to open and close the fluid supply path. The fluid supply path may be removable and the valve means preferably does not come into contact with fluid flowing through said fluid supply path. Alternatively, the fluid supply path may be fixed within the dispenser.

Preferably, said sensed data relates to usage and/or to operation of said apparatus.

Preferably, the dispenser comprises means for generating said sensed data. The data generating means may comprise means for measuring flow of fluid through said fluid supply path. The measuring means may comprise a flowmeter.

Preferably, the data generating means includes means for sensing a period of time for which said valve means is open. Preferably, the dispenser comprises means for calculating an approximate amount of fluid supplied based upon the length of the period for which said valve means is open.

Preferably, said data generating means comprises means for determining whether or not a fluid container is attached to or mounted on said dispenser. The determining means may comprise a microswitch.

Preferably, the dispenser comprises means for chilling fluid, and said data generating means includes means for measuring the temperature of fluid chilled by said chilling means. The temperature measurement means preferably comprises a thermistor.

The means for chilling fluid may comprise a refrigeration circuit having a compressor, a condenser, an expansion valve and an evaporator, said evaporator being arranged in a coil to provide a chiller cavity through which a portion of said fluid supply path passes. Preferably, the temperature sensing means is provided within said chiller cavity.

The data generating means may comprise means for determining when said valve means is opened or closed. The determining means may comprise a microswitch.

The generating means may comprise means for sensing the ambient temperature of the environment in which said dispenser is located. The temperature sensing means may comprise a thermistor.

Preferably, the data generating means comprises means for determining whether or not said dispenser includes a fluid supply path. The determining means may comprise a microswitch.

Preferably, the data generating means comprises means for determining whether or not the dispenser is being supplied with mains power.

Preferably, the dispenser comprises a logic module that includes said communications means. Preferably, the logic module further comprises processor means and memory means. Preferably, the processor means is capable of receiving data generated by said data generating means. More preferably, the processor means is operable to control said dispenser on the basis of data generated by said data generating means.

The processor means may be configured to instruct said memory means to store data generated by said data generating means.

Preferably, the processor means is operable to instruct said communications means to transmit data generated by said data generating means to a remote location.

The communications means may comprise means for establishing a wireless communications link to said remote location, e.g. a wireless cellular link to said remote location or a GSM cellular link.

The communication means may alternatively comprise means for establishing a radio frequency (RF) link to said remote location, means for establishing a satellite link to said remote location or means for establishing a wired link, via a PSTN, LAN or WAN for example, to the remote location.

Preferably, the processor is operable to switch power supply to said logic module (and possibly also to the dispenser as a whole) from the mains supply to a battery supply if said determining means determines that the dispenser is not being supplied with mains power.

Preferably, the communications means is operable to receive data from said remote location.

Preferably, the dispenser comprises means for displaying data. The display means may comprise a screen.

Preferably, the dispenser comprises user input means for the input of data into the dispenser. The user input means may comprise one or more keys or a touch sensitive screen. Preferably, the screen is operable to display data received via said communications means from said remote location.

Another aspect of the invention provides a computer system comprising: local data storage means; communications means operable to establish a link to a dispenser for water; and an execution environment capable of running a computer program which periodically establishes said link to said dispenser and uploads data from said dispenser to said local data storage means.

A further aspect of the invention provides a network comprising: a plurality of dispensers for water; and a computer system comprising: local data storage means; communications means operable to establish a link to each of said dispensers; and an execution environment capable of running a computer program which establishes a link to and polls each of said dispensers and uploads data from each dispenser to said local data storage means.

Preferably, the network or computer system comprises a computer program which is operable to process said data. Preferably, the computer program is operable to download data and/or information and/or instructions from said computer system to said dispenser or dispensers.

Another aspect of the invention provides a method of monitoring a dispenser for drinking water from a remote location. the method comprising the steps of: periodically establishing a communications link to said dispenser from said remote location; and uploading over said link data from said dispenser to said remote location.

The method may comprise the step of processing at said remote location data uploaded from said dispenser. Preferably, the data comprises sensed data relating to usage and/or operation of said dispenser or data inputted into said dispenser.

The method may comprise the step of downloading from said remote location over said link to said dispenser data and/or information for display by said dispenser.

The method may comprise the step of downloading from said remote location over said link to said dispenser operating instructions for said dispenser. The operating instructions may comprise one or more computer software portions, said one or more software portions being configured to reprogram programmable logic of said dispenser.

A further aspect of the invention provides a computer program product loadable into the memory of a digital computer, comprising one or more software portions for performing one or more of the steps of the method described herein in any combination or permutation when run on a computer.

A further aspect of the invention provides a computer useable storage medium having a computer program product thereon.

In accordance with another aspect of the invention, there is provided a dispenser for drinking water, the dispenser comprising: a fluid supply path; valve means operable to open and close the fluid supply path; means for generating data relating to usage and/or to operation of said apparatus; and means for communicating said data to a remote location.

In this preferred embodiment, the fluid supply path is replaceable and the valve means does not come into contact with water supplied through said fluid supply path. In this embodiment, the data generating means includes means for sensing the period of time for which said valve means is open, and means for calculating an approximate amount of water supplied based upon the length of the period for which said valve means is open.

This preferred embodiment is highly advantageous as it allows the amount of water supplied to be estimated without having to use devices such as flowmeters placed in the fluid supply path. As a consequence of this, cleaning of the dispenser—and in particular the fluid supply path—is greatly simplified.

Embodiments of the invention will now be described with reference to the accompanying drawings, in which:

FIG. 1 is a schematic representation of a previously proposed water dispenser;

FIG. 2 is a schematic view of part of the dispenser of FIG. 1;

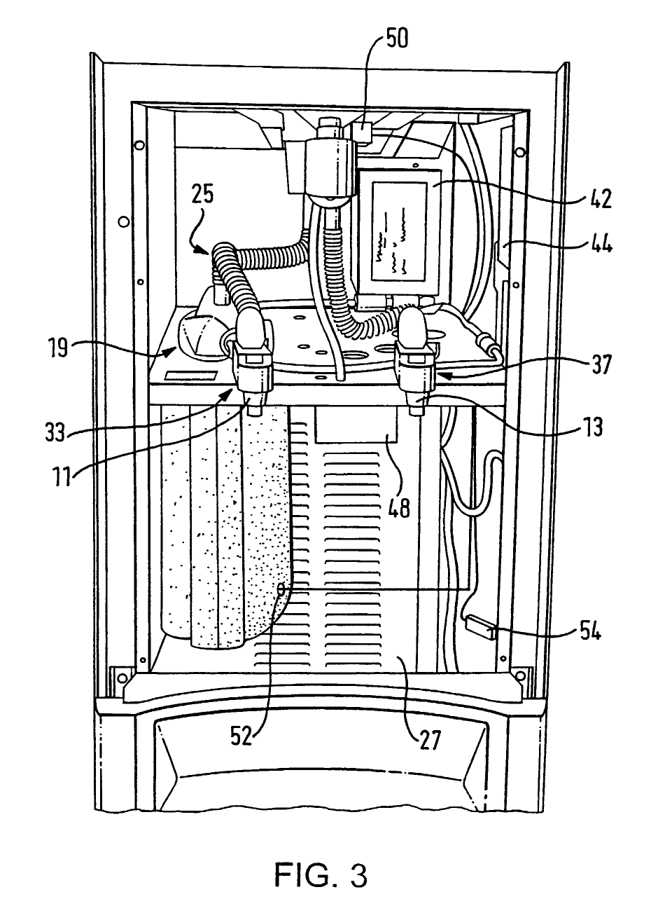

FIG. 3 is a schematic representation of part of a dispenser according to a first embodiment of the invention;

FIG. 4a is a plan view of a valve in a closed position;

FIG. 4b is a plan view of the valve is an open position;

FIG. 4c is a perspective view of a pivoting component of the valve;

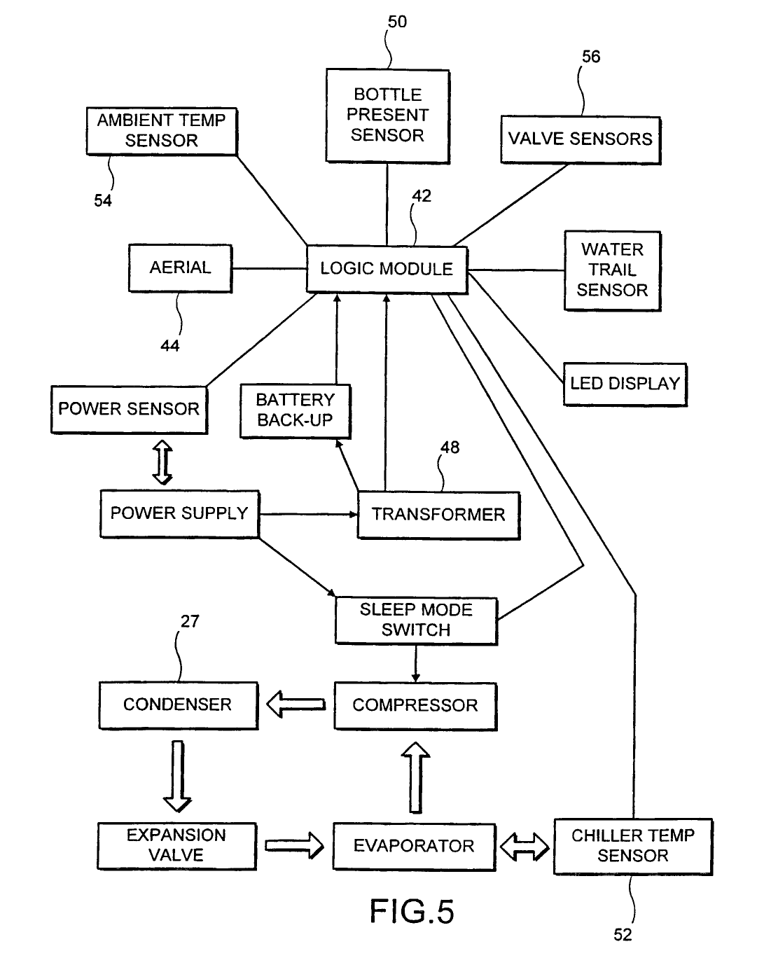

FIG. 5 is schematic block diagram of the functional components of the dispenser of FIG. 3;

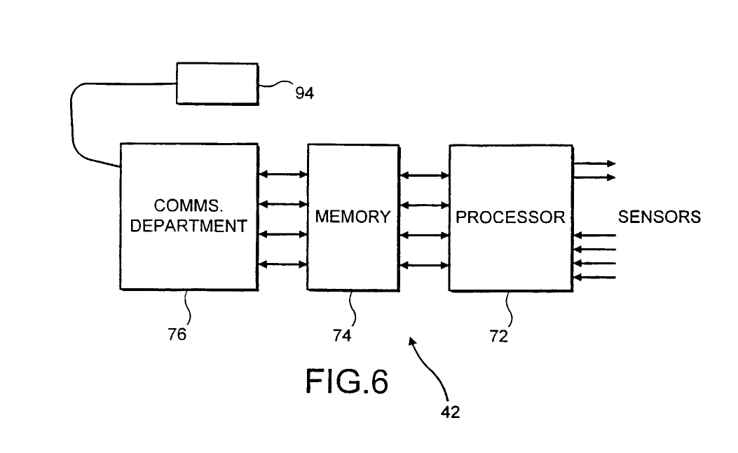

FIG. 6 is a schematic block diagram of the functional components of a logic module;

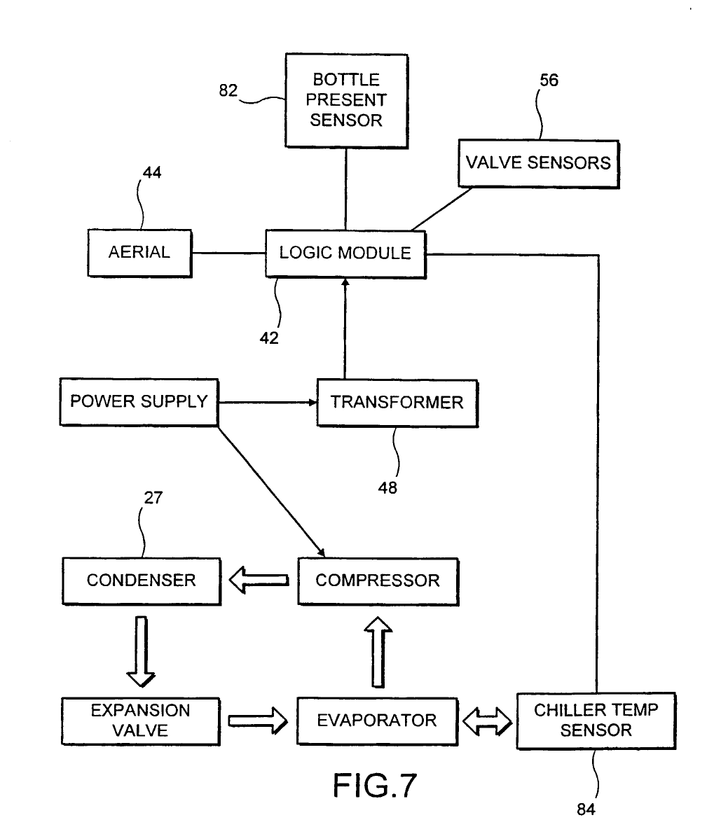

FIG. 7 is a schematic block diagram of the functional components of a dispenser according to a second embodiment of the invention

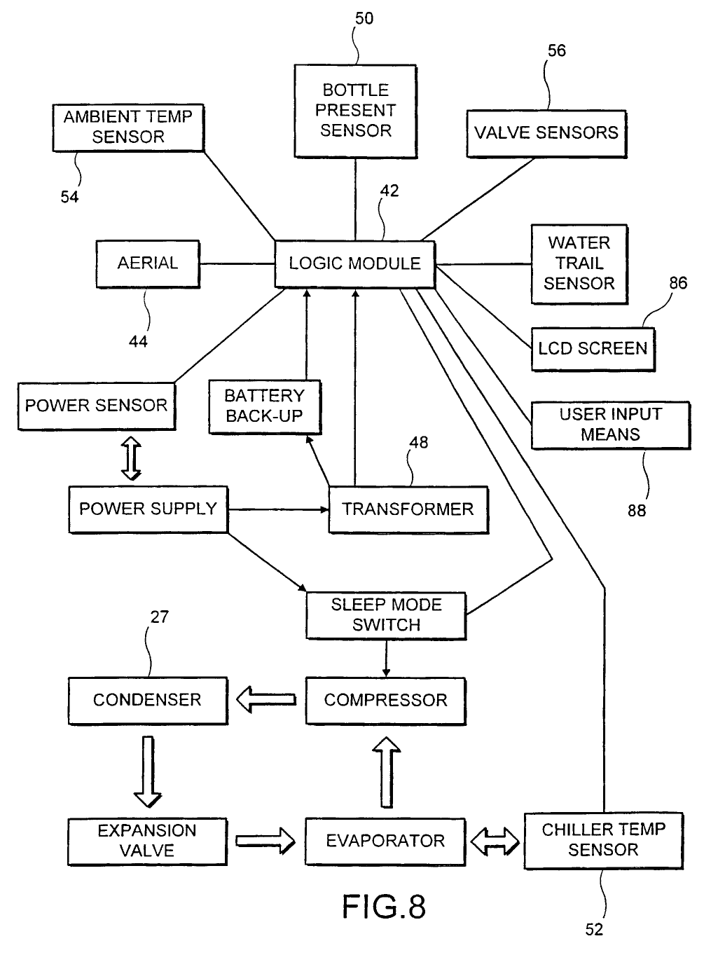

FIG. 8 is a schematic block diagram of the functional components of a dispenser according to a third embodiment of the invention;

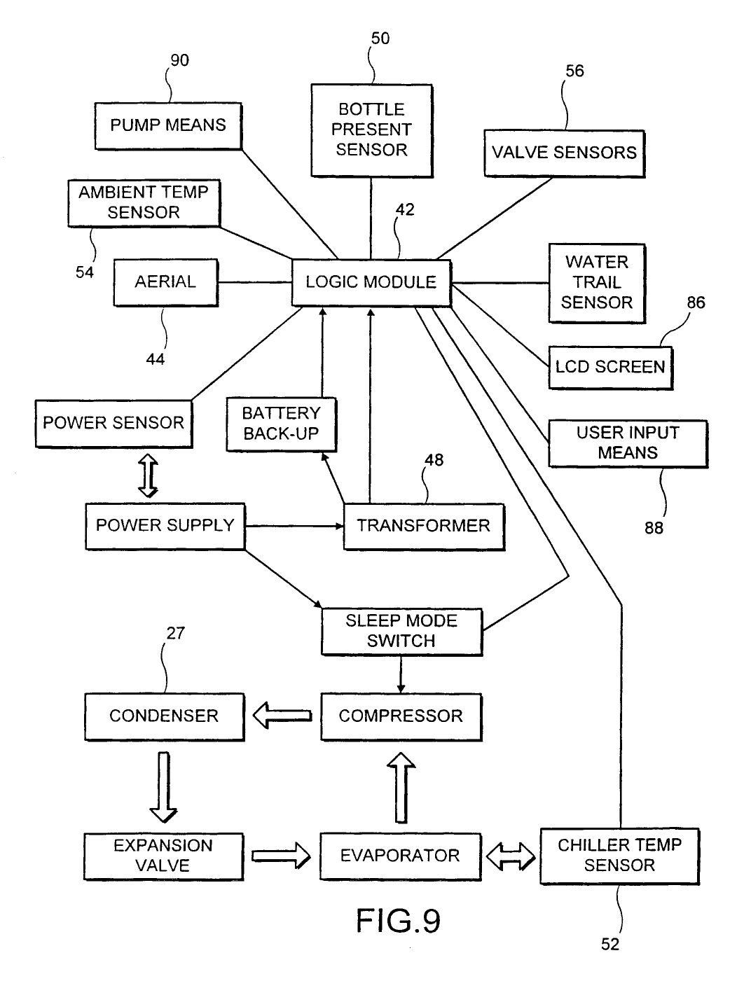

FIG. 9 is a schematic block diagram of the functional components of a dispenser according to a fourth embodiment of the invention; and

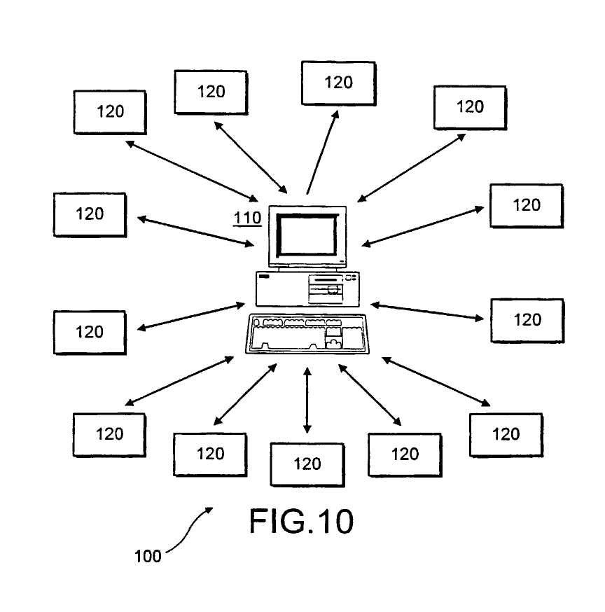

FIG. 10 is a schematic representation of a dispenser network.

Referring to FIG. 3, it will be appreciated that the dispenser 40 has a similar construction and outward appearance (not shown) to that of the dispensers of FIGS. 1 and 2, and it should be noted that like reference numerals indicate like components.

The dispenser 40 includes a refrigeration circuit which operates in the same way as the abovedescribed dispenser, and of which the condenser 27 is visible. A water trail 25, a chiller cavity 19, and a pair of dispensing valves 33, 37 are provided and these components have the same construction and function as the corresponding devices in the dispensers of FIGS. 1 and 2.

In addition to the components illustrated in FIGS. 1 and 2, the dispenser of this embodiment comprises a logic module 42 which includes communications, memory and processing components.

In this embodiment the module 42 is connected to an aerial 44 mounted inside the cabinet 3 and the communications components are capable of establishing a wireless cellular GSM link via the aerial 44 to a remote location.

It will be appreciated, however, that the communications components could instead be configured to provide other types of wireless link (for example a radio frequency (RF) link or a satellite communications link), a wired telephonic link (via a PSTN (public switched telephone network), WAN (wide area network) or LAN (local area network) for example) or a wired or wireless optical link.

Power for the module is taken from a transformer 48 which is connected to the power supply for the compressor (not shown). In the event of a power failure, a rechargeable battery (not shown) is provided to maintain power to the module 42 until mains power is resumed. The module 42 is further connected to a number of additional sensing devices as will now be described.

As shown, the module 42 is connected to a bottle detector 50 that is mounted in the socket 6, and which in this embodiment comprises a microswitch that is activated when a bottle is mounted on the dispenser. In the preferred embodiment, the microswitch is adapted for use in a fluid environment and may comprise an IP65 type switch that is capable of functioning even when immersed in fluid. Alternatively, the bottle detector 50 could be any one of a number of different types of switches, such as for example a light detector or a reed switch.

The module 42 is also connected to a chiller temperature sensor 52 which in the preferred embodiment is a thermistor, or other type of electronic temperature sensor such as a thermocouple for example. The temperature sensor 52 is located within a heat conductive pipe which is inserted through the insulating jacket of the chiller into the chiller cavity. An ambient temperature sensor 54 is also connected to the module 42, and is provided for sensing the ambient temperature of the environment in which the dispenser 40 is located.

The module could, in one embodiment, use data from the chiller sensor 52 to determine whether or not the refrigerant circuit should be operated. In this example, the module may only activate the refrigerant circuit (by allowing the supply of power to the compressor) if the sensed chiller temperature is above a pre-set maximum threshold—which could be inputted by the user or adjusted remotely. Similarly, the module may automatically stop the refrigerant circuit (by switching off the supply of power to the compressor) if the sensed chiller temperature drops below a pre-set minimum threshold—which again could be inputted by the user or adjusted remotely. In this way, the dispenser could be operated in an intermittent mode (which will reduce the power consumption of the dispenser) where the refrigerant circuit will only be active when the water is too hot, and will be deactivated when the water is too cold.

In a further enhancement, this arrangement could be operated in conjunction with the ambient temperature sensor so that the maximum and minimum thresholds are automatically adjusted to be within a present temperature range or temperature value of the ambient temperature.

A water trail detector (not shown), which in the preferred embodiment is an IP65 type microswitch, is provided that is operable to detect whether or not a water trail 25 is present within the dispenser 40.

The module may use information derived from the water trail sensor to determine when the water trail should next be removed for cleaning or replacement, and could advise the user when cleaning and/or replacement is required.

The module 42 is also connected to a mains power supply sensor (not shown) which is operable to detect whether or not the dispenser is being supplied with power. The module is advantageously operable to take power from the rechargeable back-up battery if the power supply sensor should indicate that the supply to the dispenser has been lost.

In this embodiment, each valve 33, 37 is provided with a microswitch 56 or other means operable to sense when the valve is opened or closed and comprises, as shown in FIG. 4a, 4b and 4c, a support mounting 58 and a pivoting member 60 which is biased, by a spring 62, into a closed position as shown in FIG. 4a As shown in FIG. 4c, the pivoting member 60 comprises an engagement surface 64 to which pressure may be applied in direction A. Applying pressure to the engagement surface 64 in direction A causes the pivoting member to rotate about a pivot axle 66 to cause a stop wall 68 of the pivoting member to move in direction B. As will be appreciated from FIGS. 4a and 4b, movement of the stop wall 68 in direction B causes an outlet 70 in the support mounting 58 to be opened. In use, the tubes 29, 31 of the water trail pass through the valve outlets 70 and the stop wall 68 of the pivoting member can be moved to close or open the fluid path. The microswitch 56 is fixed to an inside wall of the support mounting and is activated when the pivoting member is moved from the valve closed position shown in FIG. 4a to the valve open position shown in FIG. 4b.

When the microswitch 56 is activated (by opening the valve) a signal is sent to the logic module 42 which starts a timer running. When the valve is closed, the microswitch is deactivated and the timer is stopped. From the length of time the valve has been open (i.e. the period of time for which the timer has run) processing components of the logic module can estimate the amount of water dispensed using a pre-programmed measurement or estimate of the amount of water that would be dispensed over a given time period.

Using the microswitches 56 in this way it is possible to generate data which provides an approximation of the amount of water that has been dispensed by the dispenser. This information is stored and eventually passed to the remote location where the supplier can use the information to accurately determine how long the customer's supply of bottled water will last if it is continued to be used at that rate. In this way, the supplier can order replacement water bottles before the customer runs out of water, and without having to wait for the customer to order fresh supplies.

This particular valve arrangement is highly advantageous as it avoids having to use flowmeters or other like devices to determine the amount of water dispensed. As a result, cleaning of the dispenser is greatly simplified as there are no sensors which come into contact with the water being dispensed. However, it will be appreciated that in other embodiments flowmeters, or other similar electronic flow measurement devices, could instead be used even though they would probably be more difficult to clean. It should further be noted that a conventional fixed fluid path could alternatively be provided.

As shown in FIG. 3, in this embodiment the dispenser is provided with a first tap 11 for dispensing chilled water and a second tap 13 for dispensing water at the ambient temperature. In further alternative embodiments a water heating unit could be connected between the socket 6 and the second tap to heat water from the bottle 5. In such embodiments, further sensors may be provided to sense the temperature of the heated water, and to sense whether or not the heating unit is being supplied with power.

The dispenser 40 may also be provided with a power-down function whereby the dispenser 40 enters a low power mode, or “goes to sleep”, if unused for a predetermined period of time. In an alternative arrangement, the dispenser may be configured to enter the low power mode at specified times of the day (for example at the end of the business day) or alternatively to enter the low power mode when a light sensor indicates that the lighting within the building in which the dispenser is located has been switched off. In the low power mode, power to the chiller unit (and/or to the heating units, if present) can be removed by opening a switch so that the only unit drawing power is the module 42.

It has also been proposed that the dispenser 40 may be provided with means for adding carbon dioxide or oxygen to the water being dispensed, as has previously been proposed for prior art dispensers.

One such previously proposed carbonating unit comprises a housing within which a fluid storage cavity is provided into which a user tips their cup of water. The user then places their cup under a nozzle in the unit and activates a valve which allows carbon dioxide from a pressurised gas bottle to flow through the water in the cavity, and the now carbonated water in the cavity to flow out of the nozzle and into the cup. A similar arrangement, but with an oxygen bottle, may be provided as an oxygenating unit—alternatively an oxygen generator may instead be provided.

If the dispenser of FIG. 3 were to be provided with an oxygenating or carbonating unit, then a gas pressure sensor may be provided which is connected to the module 42, and which indicates the gas pressure within the gas bottle. In this way, the module 42 can determine whether or not the gas bottle needs replacing.

In a preferred variant of this embodiment, the module is connected to a display means which comprises a series of light emitting diodes (LEDs) (not shown) which may be differently coloured, and which may be used to indicated the operating state of the dispenser.

For example, a green LED indicating the dispenser is functioning correctly may be lit if the bottle and water trail sensors indicate that a bottle and a water trail are present, if the power sensor indicates that the power supply to the dispenser is functioning, and if the chiller temperature sensor indicates that the water has been chilled to within a predetermined range. Alternatively, a red LED may be lit indicating a fault if the water trail or the bottle are not present or if the power supply should be interrupted. In addition, an amber LED may be lit if the bottle and water trail sensors indicate that a bottle and a water trail are present, if the power sensor indicates that the power supply to the dispenser is functioning, and if the chiller temperature sensor indicates that the water has not yet been chilled to within the above mentioned predetermined range.

In this way, a user of the dispenser will know—depending upon the colour of the LED that is lit—whether the dispenser is functioning correctly, whether it is experiencing a fault or whether the water within the dispenser has not yet been sufficiently chilled (as might happen, for example, if the water bottle has only recently been replaced).

In a further variant of this embodiment, additional LEDs may be provided to indicate exactly which component or components of the dispenser are malfunctioning if the red LED should be lit.

As mentioned above, FIG. 5 is a schematic block diagram of the functional components of the dispenser 40 of FIG. 3.

As shown, the logic module 42 is connected to the chiller temperature sensor 52, the water trail sensor, the valve sensors 56, the bottle sensor 50, the ambient temperature sensor 54 and the power sensor. The logic module 42 is also connected to the abovementioned sleep mode switch so that the power supply to the compressor can be controlled.

As mentioned above, the logic module collects data when the valves 33, 37 are opened, and from this data calculates an approximation of the amount of water dispensed. The approximate total amount of water dispensed is then stored, and can be transmitted to a remote location where the supplier can act upon the information received. Alternatively, the data itself may be transmitted to the remote location for processing. The logic module is also able to collect data when the water trail or water bottle is replaced and this data can be relayed to the remote location for use by the supplier.

The logic module is also capable of monitoring the ambient temperature and the chiller temperature, and can be programmed to relay this information to the remote location as an indication of whether or not the dispenser is operating correctly. Alternatively, the logic module can act on this information using the sleep mode switch to activate or deactivate the compressor and hence control cooling of the water within the dispenser. The logic module is also able to record other sensed component faults within the dispenser and to transfer information concerning those faults to the remote location so that the supplier is aware of the problem and can take appropriate action.

The logic module is also capable of relaying information signals to a user of the dispenser by way of the LED display. The information relayed may simply indicate whether or not the dispenser is functioning correctly, or it may specify exactly where a fault with the dispenser lies, or simply that the dispenser has not yet reached its optimum operating state.

Data transfer between the dispenser and the remote location can occur by one or both of two different mechanisms. In the first mechanism each dispenser can dial up a central computer at the remote location and upload stored data thereto once a link has been established. However, this arrangement could cause problems if several dispensers should all try to dial up the remote location at the same time, and thus it is preferred for the central computer at the remote location to periodically establish a communications link with each dispenser (i.e. to poll each dispenser) and to upload information therefrom.

FIG. 6 is a schematic block diagram of the functional components of the logic module. As shown the logic module 42 comprises a processor 72 (which is preferably—but not necessarily—programmable), memory 74 and a communications component 76 which in this embodiment is a GSM cellular transceiver.

The processor 72 receives inputs from each of the various sensors, and in addition is capable of sending signals to the sleep mode switch and to the LED display. The memory component 74 is capable of recording data generated by the sensors, and can also act as a send or receive buffer for the communications component 76.

The communications component 76 is capable of sending or receiving signals from the remote location. This is advantageous as it enables the supplier at the remote location to remotely re-programme the customers dispenser, perhaps to adjust the operating temperature range to which water is cooled by the dispenser.

Whilst the above described arrangement is presently preferred, FIG. 7 is a schematic block diagram of the functional components of a simpler dispenser according to a second embodiment of the invention. In this embodiment, the dispenser is only provided with a pair of valve sensors, a bottle sensor 82 and a chiller unit temperature sensor 84. The dispenser of this embodiment, whilst being less sophisticated than the previously described dispenser, still allows the amount of water used and the number of bottles used to be monitored and information relating to that monitoring to be relayed to the remote location so that the supplier can better provide for the customers needs. In addition, by monitoring the chiller temperature it is possible for the supplier to determine whether or not the refrigeration circuit is working properly, and for the supplier to take any remedial action required.

FIG. 8 is a schematic block diagram of the functional components of a dispenser according to a third embodiment of the invention. In this embodiment, the LED display of FIG. 5 has been replaced with a screen 86 which in this embodiment is an LCD screen. A user input device 88, such as a small keyboard or a selection of buttons for example may also be provided so that a user can input information or can select options from menus displayed on the screen. The user input device could also be a touch sensitive screen mounted over the screen 86.

As mentioned above, the communications component of the logic module is capable of transmitting and receiving signals to and from the remote location. Thus information can be transmitted from the remote location to the dispenser for display on the screen. The information could be of an entertainment nature, for example the scores from sporting fixtures, or alternatively it could of a business nature such as the latest stock prices. The information could also be a set of instructions on how to rectify a fault that has been detected in the dispenser and notified to the remote location.

The user input device 88 is provided so that a user can relay information to the suppliers, such as for example an order for a supply of water bottles, or a supply of cups. The customer order can be stored in the memory component and then uploaded to the remote location when a link is next established between the remote location and the dispenser, or in the preferred embodiment when the remote location next calls the dispenser and uploads information therefrom.

FIG. 9 is a schematic block diagram of the functional components of a dispenser according to a fourth embodiment of the invention. The only difference between this embodiment, and the embodiment of FIG. 8 is that in this embodiment pump means 90 are provided for pumping water from the water bottle 5.

The pump means of this embodiment is advantageous as it allows the overall size of the dispenser to be reduced. In the embodiment of FIG. 5, the water bottle must be located a quite considerable distance above the valves as the water is gravity fed from the water bottle. Accordingly, the smaller the vertical distance between the valves and the bottle, the smaller the pressure at which water is dispensed.

Where space considerations are not important, this requirement does not really cause any problems. However, when it is desired to place a water dispenser into a confined space or onto a table or kitchen worksurface, for example, it is no longer possible to rely on a gravity feed as the dispenser must be more compact, and as a result the water bottle is not sufficiently elevated above the nozzles to provide a suitable dispense pressure.

To avoid this problem it has therefore been proposed in this embodiment to provide pump means which pumps air into the water bottle to drive water therefrom. In the preferred embodiment, the pump means is connected to the logic module so that as either of the valves are opened, the pump means is operated to pump air into the bottle to dispense water; and so that as the valves are closed operation of the pump means is ceased.

As a variant of this embodiment, it will be appreciated that it is not necessary to pump air into the water bottle. In an alternative arrangement, pump means are provided with are operable to suck water from the water bottle, the water removed from the bottle being replaced by air bled into the bottle via a suitable valve.

As with the aforementioned embodiments, the dispenser of this embodiment can be provided with one, some or all of the sensors of the previous embodiments and is operable to transmit and/or receive signals from a remote location.

FIG. 10 is a schematic representation of a network comprising a remote location and a plurality of dispensers according to any of the embodiments previously described (although it will be appreciated that the teachings of the invention may equally well be applied to a single dispenser monitored from a remote location).

As shown, the network 100 comprises a remote location 110 which is a computer, and which may be located at the suppliers premises. The computer comprises all the normal components of a modern computer system including a screen, keyboard, storage, a processor and memory and also includes in the preferred embodiment a GSM wireless telecommunications device (which is effectively a wireless GSM modem) for communication with similar devices housed in dispensers 120 remotely located in the premises of the supplier's customers, for example. Each dispenser GSM communication device is assigned a different “telephone” number, and thus the number assigned to a particular dispenser can be used to unique address and identify that dispenser from a plurality of dispensers.

As described above, the network 100 may be operated in one of two ways. In the first way, the logic module of the dispensers establish connections to the computer at the remote location 110 and upload information and data thereto. This mechanism can be disadvantageous, however, as the connection to the computer 110 may be busy dealing with another dispenser when another one of the dispensers attempts to contact it.

To avoid such problems it is preferred that the computer system 110 at the remote location dials out to each of the dispensers in turn (i.e. polls each of the dispensers) and uploads data and information therefrom.

Once all the data and information has been uploaded from the various dispensers, suitable software at the remote location interprets the uploaded data and presents it to the supplier in a variety of user selectable formats. For example, the supplier may choose to look at past water usage for some or all dispensers in a particular area for any given period of time. Alternatively, the supplier could choose to look at water usage for a particular dispenser over a given period of time. As a further alternative, the supplier could use present data and previously obtained data to determine likely usage for that area or for a particular dispenser over a future period of time, which will greatly assist the supplier when he comes to order more product for supply.

Whilst in the preferred embodiment the dispensers are linked to the remote location by a GSM wireless link. it should be noted that this is not essential and the link may be established using other wireless telecommunications technology (such as an RF link or a satellite link for example) or wired telecommunications technology (such as via a PSTN, LAN or WAN for example).

As a variant to this preferred network embodiment, the computer at the remote location may comprise a web server, or an internet server on which a website is established. The supplier can then log into the website established and maintained on the server and, probably over a secure link, inspect and manipulate the data recovered from the various dispensers.

In addition to the recovery of data from the dispensers, the computer at the remote location 110 is also operable to transmit information and/or data to the dispensers. For example, the information/data may comprise entertainment data, or fault rectification instructions for display to a user on the display means. The information/data may alternatively be used to reprogram the dispenser modules with, for example, new temperature ranges or other operating instructions.

It will be understood, and should be noted, that many modifications may be made without departing from the scope of the invention.

For example, the dispenser may include a warning display device such as a buzzer or light which operates to audibly or visibly warn a user of faults with the dispenser which can be fixed by the user. The warning display device may be coupled to a proximity detector so that the warning is only emitted when someone is in the vicinity of the dispenser, rather than being continuously emitted.

As a further alternative, the dispenser may include any one or more of a variety of storage media such as a CD-Rom players, DVD player or video tape players or the like from which data may be recovered for display on the display device of certain of the embodiments described herein. In this embodiment, the dispenser could be operable to recover fault rectification information or operating instructions, for example, from the storage for display.

It should also be noted that whilst the embodiments described above predominately utilise microswitches, a variety of different types of sensors or detectors may be used. For example, the microswitches could be replaced by reed switches or one of many other types of optical, electrical or mechanical switches. The cup dispenser 17 could even be provided with an appropriate sensor or switch to indicate when the dispenser has run out of cups.

It should also be noted that whilst the module has been described herein in terms of separate dedicated components, those components could instead be provided in a single logic unit such as an ASIC, for example.

1. A dispenser for drinking water which comprises means for chilling water; means for generating sensed data; and communications means for relaying said sensed data or inputted data to a remote location.

2. A dispenser according to claim 1, comprising a fluid supply path, and valve means operable to open and close the fluid supply path.

3. A dispenser according to claim 2, wherein the fluid supply path is removable and the valve means does not come into contact with fluid flowing through said fluid supply path.

4. A dispenser according to claim 2, wherein the fluid supply path is fixed within the dispenser.

5. A dispenser according to any preceding claim wherein said sensed data relates to usage and/or to operation of said apparatus.

6. A dispenser according to any preceding claim, wherein said data generating means comprises means for measuring flow of fluid through said fluid supply path.

7. A dispenser according to claim 6 wherein, said measuring means comprises a flowmeter.

8. A dispenser according to claim 6 when dependent upon claim 2, wherein said data generating means includes means for sensing a period of time for which said valve means is open.

9. A dispenser according to claim 8, comprising means for calculating an approximate amount of fluid supplied based upon the length of the period for which said valve means is open.

10. A dispenser according to any of previous claim, wherein said data generating means comprises means for determining whether or not a fluid container is attached to or mounted on said dispenser.

11. A dispenser according to claim 11, wherein said determining means comprises a microswitch.

12. A dispenser according to any preceding claim wherein said data generating means includes means for measuring the temperature of fluid chilled by said chilling means.

13. A dispenser according to claim 12, wherein said temperature measurement means comprises a thermistor.

14. A dispenser according to claim 12 or 13 when dependent on claim 2, wherein said means for chilling fluid comprises a refrigeration circuit having a compressor, a condenser, an expansion valve and an evaporator, said evaporator being arranged in a coil to provide a chiller cavity through which a portion of said fluid supply path passes.

15. A dispenser according to claim 12 or 13 and claim 14, wherein said temperature sensing means is provided within said chiller cavity.

16. A dispenser according to claim 2 or any of claims 3 to 15 when dependent on claim 2, wherein said data generating means comprises means for determining when said valve means is opened or closed.

17. A dispenser according to claim 16, wherein said determining means comprises a microswitch.

18. A dispenser according to any preceding claim, wherein said data generating means comprises means for sensing the ambient temperature of the environment in which said dispenser is located.

19. A dispenser according to claim 18, wherein said temperature sensing means comprises a thermistor.

20. A dispenser according to any preceding claim, wherein said data generating means comprises means for determining whether or not said dispenser includes a fluid supply path.

21. A dispenser according to claim 20, wherein said determining means comprises a microswitch.

22. A dispenser according to any preceding claim, wherein said data generating means comprises means for determining whether or not the dispenser is being supplied with mains power.

23. A dispenser according to any preceding claim, comprising a logic module that includes said communications means.

24. A dispenser according to claim 23, wherein said logic module further comprises processor means and memory means.

25. A dispenser according to claim 24, wherein said processor means is capable of receiving data generated by said data generating means.

26. A dispenser according to claim 25, wherein said processor means is operable to control said dispenser on the basis of data generated by said data generating means.

27. A dispenser according to claim 25 or 26, wherein said processor means is configured to instruct said memory means to store data generated by said data generating means.

28. A dispenser according to any of claims 25 to 27, wherein said processor means is operable to instruct said communications means to transmit data generated by said data generating means to a remote location.

29. A dispenser according to any preceding claim, wherein said communications means comprises means for establishing a wireless communications link to said remote location.

30. A dispenser according to claim 29, wherein communications means comprises means for establishing a wireless cellular link to said remote location.

31. A dispenser according to claim 30, wherein communications means comprises means for establishing a GSM cellular link.

32. A dispenser according to claim 29, wherein said communication means comprises means for establishing a radio frequency (RF) link to said remote location.

33. A dispenser according to claim 29, wherein said communications means comprises means for establishing a satellite link to said remote location.

34. A dispenser according to any of claims 1 to 28, wherein said communications means comprises means for establishing a wired link, via the PSTN for example, to the remote location.

35. A dispenser according to claim 22 and claim 24, wherein said processor is operable to switch power supply to said logic module (and possibly also to the dispenser as a whole) from the mains supply to a battery supply if said determining means determines that the dispenser is not being supplied with mains power.

36. A dispenser according to any preceding claim wherein said communications means is operable to receive data from said remote location.

37. A dispenser according to any preceding claim, wherein said dispenser comprises means for displaying data.

38. A dispenser according to claim 37, wherein said display means comprises a screen.

39. A dispenser according to any preceding claim, comprising user input means for the input of data into the dispenser.

40. A dispenser according to claim 29, wherein the user input means comprises one or more keys or a touch sensitive screen.

41. A dispenser according to claim 37, wherein said screen is operable to display data received via said communications means from said remote location.

42. A computer system comprising
local data storage means;
communications means operable to establish a link to a dispenser for water; and
an execution environment capable of running a computer program which periodically establishes said link to said dispenser and uploads data from said dispenser to said local data storage means.

43. A network comprising:
a plurality of dispensers for water each of said dispensers comprising means for chilling water and communications means for relaying sensed data or inputted data; and
a computer system comprising: local data storage means; communications means operable to establish a link to each of said dispensers; and an execution environment capable of running a computer program which establishes a link to and polls each of said dispensers and uploads data from each dispenser to said local data storage means.

44. A network or computer system according to claim 42 or 43, wherein said computer program is operable to process said data.

45. A network or computer system according to any of claims 42 to 44, wherein said computer program is operable to download data and/or information and/or instructions from said computer system to said dispenser or dispensers.

46. A method of monitoring a dispenser for water from a remote location, the method comprising the steps of:
periodically establishing a communications link to said dispenser from said remote location; and
uploading over said link data from said dispenser to said remote location.

47. A method according to claim 46, comprising the step of processing at said remote location data uploaded from said dispenser.

48. A method according to claim 46 or 47, wherein said data comprises sensed data relating to usage and/or operation of said dispenser or data inputted into said dispenser.

49. A method according to any of claims 46 to 48, comprising the step of downloading from said remote location over said link to said dispenser data and/or information for display by said dispenser.

50. A method according to any of claims 46 to 49, comprising the step of downloading from said remote location over said link to said dispenser operating instructions for said dispenser.

51. A method according to claim 50, wherein said operating instructions comprise one or more computer software portions, said one or more software portions being configured to reprogram programmable logic of said dispenser.

52. A computer program product loadable into the memory of a digital computer, comprising one or more software portions for performing one or more of the steps of the method according to any of claims 46 to 51 in any combination or permutation when run on a computer.

53. A computer usable storage medium having a computer program product according to claim 52 stored thereon.

54. A dispenser substantially as hereinbefore described with reference to the accompanying drawings.

55. A computer system substantially as hereinbefore described with reference to the accompanying drawings.

56. A network substantially as hereinbefore described with reference to the accompanying drawings.

57. A method substantially substantially as hereinbefore described with reference to the accompanying drawings.

58. A computer program substantially as hereinbefore described.

59. A computer useable storage medium substantially as hereinbefore described.
